(19) United States
(12) Patent Application Publication
(10) Pub. No.: US 2023/0058724 A1
(43) Pub. Date: Feb. 23, 2023

(54) DEMON quantum mehanical (H/C)/propulsion system

(71) Applicant: Stephen Richmond Cummings, Pasadena, CA (US)

(72) Inventor: Stephen Richmond Cummings, Pasadena, CA (US)

(21) Appl. No.: 16/501,665

(22) Filed: May 20, 2019

(51) Int. Cl. F03H 1/00; B64G 1/40; B64G 1/50

(52) U.S. Cl. CPC F03H 1/0081; B64G 1/405; B64G 1/50

(57) ABSTRACT

This device, the (‘Demon’ Quantum Mechanical, (H/C)/(Propulsion) system), replaces entirely, the (antiquated system of using Cryogens for cooling, in satellite applications). This device, is the ONLY application, which uses (Quantum Mechanics) for Propulsion/Thrusting. This device is the ONLY design to use (Quantum Mechanics) to (simultaneously Heat and Cool) in any application. This device is the ONLY design to use (Quantum Mechanics) to (simultaneously Heat and Cool) and for (Propulsion) in any application, —and due to the system (operating methods) and (weightless environment), —with EXPONENTIALLY greater (fuel) efficiency. This device (extends the (working service life) of Satellites requiring cooling) from MONTHS, to 50+ YEARS/more.

### BACKGROUND OF THE INVENTION

The (‘Demon’ Quantum Mechanical (Heating/Cooling) and (Propulsion) System), (see FIG. 1) was conceived (2017) and designed (2018), to perform a specific application, (where cooling was required, but where cryogens were not feasible), and to perform that application/task of cooling/and heating, within a specific satellite/satellite system (a dedicated group of satellites). The (Propulsion part of the system), was conceived/designed at the same time. The propulsion unit (addition of exhaust lines/combustion chamber/thruster cup) takes advantage of the (temperature differential of the (H/C Exhaust gases)/rubidium dust), which ignite in the (combustion) chamber, creating thrust, creating propulsion. The propulsion unit was/(is for that application), —used as a station-keeping thruster/(standard propulsion unit, employing a (combustion chamber)/(thruster cup)), (Note here: conceivably, cesium, can be used as well as rubidium).

The (‘Demon’ Quantum Mechanical (Heating/Cooling) and (Quantum Mechanical, Ion-Jet Drive Propulsion System), is designed specifically primarily for propulsion, and/or for (high performance propulsion), —also (takes advantage of the (temperature differential of the (H/C Exhaust gases)/rubidium dust), but it also takes advantage of the thrust created by the electrical charging of the (Cold exhaust gases) creating ionization, creating thrust), AND (Jet created by combination of superheated gases sprayed out a nozzle in the center of the cup) and the (ignition/expansion/expanding force—(i.e. thrust) created by combining same within the cup. It employs only ((A power source—RTG(Radio-Isotope Thermal Generator)/other), (a ‘Demon’ Quantum Mechanical (Heating/Cooling) and (Propulsion) System), (a Thrust Cup feed/charging ring), a (vented Thrust Cup) and (Hot Exhaust nozzle). The potential of this “Engine” is significant, —(due to the fact that: —The COLD scale is limited (to absolute zero), —there is however (potentially no limit/no known limit to—the HOT scale), —thus, —potentially no limit to the (Temperature differential of (exhaust gases, H/C)), and thus, —(potentially no limit to the energy/thrust possible). The fastest thing ever built by man (the DAWN New Horizons Satellite achieved (150,000 MPH with gravity assist)), (This Engine should/may, be able to achieve speeds of (300,000 MPH) possibly higher, —and that without gravity assist.
“To BOLDLY GO, where no man has gone before” . . . Mars in 6.4 days . . . Jupiter in 59 days . . . . . . NEPTUNE, 12.5 months . . .

### BRIEF SUMMARY OF THE INVENTION

Simplicity itself, —this device “Breath's” like a lung. Though not air, —the absence of it. (RTG/other powered), it is (laser/quantum mechanically, charged and controlled), and (ambient vacuum operated).

Operated in Space, (aboard satellite systems), —the (‘Demon’ Quantum Mechanical (Heating/Cooling) and (Propulsion) System, can achieve much higher and lower temperatures than cryogens(cooling)/(solar/RTG/other power source (heating)), —THIS SYSTEM REPLACES ENTIRELY THE (antiquated system of cryogens as a coolant), and with EXPONENTIALLY LESS FUEL SOURCE (mass/weight) REQUIRED to perform (not only the same, but MUCH more of the same task /and-or more tasks). THIS SYSTEM EXTENDS THE SERVICE LIFE OF ANY (Satellite requiring cooling, and-or H/C), from MONTHS (Cryogens), to (50+ years/or more, (‘Demon’ Quantum Mechanical (Heating/Cooling) and (Propulsion) System)).

The ENTIRE SYSTEM HAS ONLY 3 MOVING parts, all operated by (friction-less, electromagnetic, electric motor)'s, with (one frictionless cam) and (one worm gear).

(NOTE: (Magnetic trap/quantum cooling technology) is not new, it was developed by (Dr. Eric Cornell (JPL), and Dr. Dan Weiman (Stanford University). Nor is (heating of gases/laser) technology, a new thing. The (‘Demon’ Quantum Mechanical (Heating/Cooling) and (Propulsion) System), is the 1^{st}/only system to combine (Simultaneous (Quantum Mechanical Heating and Cooling), and for the purpose of (replacing the use of cryogens entirely) and (for propulsion).

### BRIEF DESCRIPTION OF THE DRAWINGS

FIG. 1—(‘Demon’ Quantum Mechanical (Heating/Cooling) and (Propulsion) System), (Front/Exposed View).

FIG. 2—(‘Demon’ Quantum Mechanical (Heating/Cooling) and (Propulsion) System), housing/bracket, (Exploded View).

FIG. 3—(‘Demon’ Quantum Mechanical (Ion-Jet Drive Engine).

### DETAILED DESCRIPTION OF THE INVENTION

The (‘Demon’ Quantum Mechanical (Heating/Cooling) and (Propulsion) System) has 4 MAIN COMPONENTS, —(Gas Generator), (H/C Unit (w/separated H/C sides)), (H/C Magnetic traps/lasers), ((Control valve)—which regulates the vacuum, exhaust, gas charging of the system, and vacuum charging/purging of the system, temperature of the system, gas mixture of the system.

(Part 1—(Gas Generator)—uses a laser, to burn (¼-½″ microns thin layers) of (rubidium compound paste solid compound), thereby creating (rubidium gas), that (rubidium gas) is (drawn by the vacuum in the system), into : the magnetic traps in (Part 2—the H/C Unit), and held there by electromagnetism. (Hot trap on one side/Cold trap on the other). Access to the (Gas Generator) is closed by the (control valve). The separate, (Hot) and (Cold) magnetic traps, (via a combination of lasers/and (operation of the magnetic traps to cool or heat respectively the H and C rubidium gases), simultaneously heat and cool the gases. (The HEAT created/(and partially the hot gases created) circulated freely (via ducting built into the unit/and satellite) to the (electronics section of the Satellite to keep it at (room temperature) to protect the electronics, and within the (double-walled construction, gas passageways surrounding the entire satellite). The COLD created//(and partially the hot gases created), circulate freely via ducting built into the unit/and satellite, to the (IR Detector/other (Part) housing), thereby providing cooling/super cooling) to the IR Detectors/other, as required.

To (Purge the system/recharge the Vacuum in the system), and-or to (thrust/propel the satellite for station-keeping), (For Propulsion—the (H and C exhaust valves are opened by the (control valve)), and the (H and C exhaust gases) are fed via (separate exhaust lines) to the (combustion chamber), where they (ignite), causing exhaust to flow out the thruster cup , creating thrust, thereby creating propulsion). (For Purging of the system/recharging of the vacuum) ONLY: —the (H Exh Bypass valve) is opened by the (control valve), and the hot gases flow out the vented thrust cup (without igniting)—(Note: in this (standard design), (H exhaust gases are fed out a purge valve, and or out a (cantilevered thrust cup) to negate any thrust created by the mixing of the H gases and the cold of Space), . . . and the (C Exh gases) are fed directly into the (combustion chamber/out the cup), —again, (without igniting), —as there is no mixture of (super-heated/super-cooled) gases.

Note: When used for (Propulsion), the (control valve), 1st (closes the back flow path to the fuel source/rubidium), then 2nd (opens the exhaust to the combustion chamber on both H and C sides), and 3rd (the exhaust gases flow to the combustion chamber), are mixed, (ignite due to temperature differential of the exhaust gases), the combusted gases flow out the cup, thereby creating thrust. Thereby creating propulsion The LEVEL OF PROPULSION ATTAINABLE IS LIMITED ONLY BY THE TEMPERATURE DIFFERENTIAL OF THE EXHAUST GASES.

### One Complete Cycle of this System is as Follows

### Begin

### All in Order as They Appear

1. The (Hot Bypass to Thrust cup), (H Purge/Charge valve), (C Exhaust valve), (Access to all gas passageways/ducting) are opened. The (H Bypass to Thrust cup) is closed. The (C Exhaust valve) is closed. THE SYSTEM IS NOW “CHARGED” WITH A VACUUM.

2. The (Gas Generator) creates (fuel/coolant/rubidium gas). The (H and C Magnetic traps) power up. The (rubidium gas) is drawn by the vacuum, into the (magnetic traps) where is it held in place by electromagnetism. The (lasers in the magnetic traps(H and C)) turn on, —whereby the (H side is heated) and (C side is chilled). Access to the (components) —(Electronics, H), (IR Detectors, for example, C). The HEAT created/(and partially the gases) flow freely around the (gas passageways (in the ‘Demon’ (H/C) Unit), and in the Satellite (via thermal double wall construction passageways/and-or ducting)), and thus (H or C to those areas required).

3. When ready to (create station-keeping thrust/other (Standard Propulsion), —(the access to the ducting/gas passageways), and (to the (H and C Satellite Components) are closed (thereby protecting the (electronics/IR Detectors)/and shutting off (vacuum pressure/possible backflow of temp changes to those areas). The (H and C Exhaust valves) are opened, (the H and C gases flow to the (combustion chamber) where (they ignite) due to (temperature differential) and (heated rubidium gas particles). The combusted gases flow out the Thruster cup, thereby creating thrust, thereby creating propulsion. When (vacuum pressure in the system is equalized to ambient (space) vacuum pressure)/all combustion has occurred, —(access to all passageways (except (H and C Satellite Components (electronics/IR Detectors), —are opened, —the system (purges itself/re-charges the vacuum), —the (H and C Exhaust valves) are closed, THE SYSTEM IS NOW RE-CHARGED WITH A VACUUM.

### End

### The Cycle Begins Again

Appendix 1—Diagram below, showing the position of valves during all phases of operation.

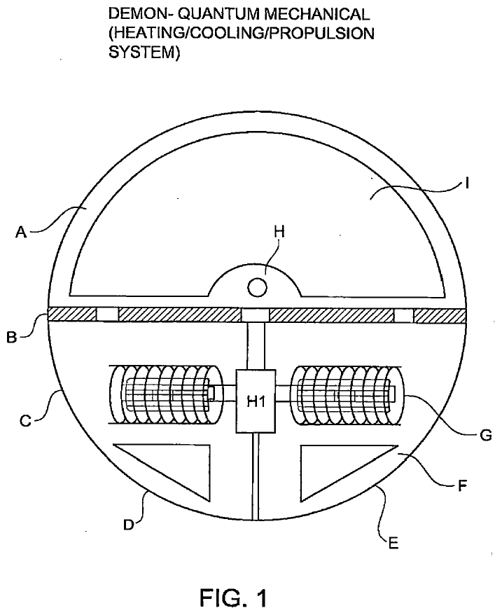

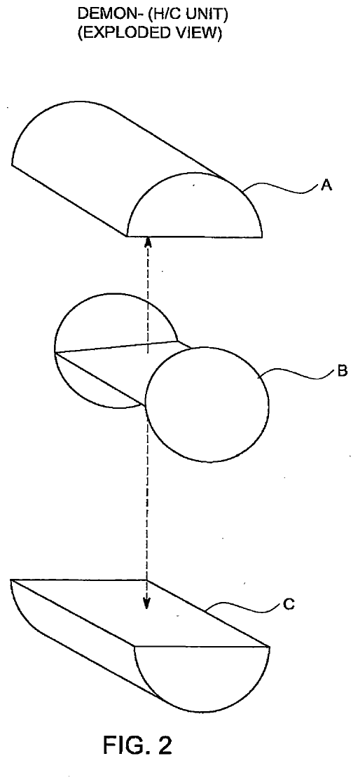

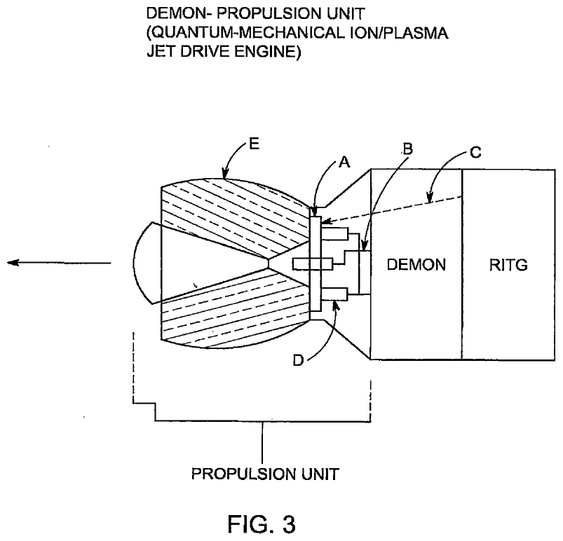

Appendix 2—Key/Legend to (“FIG. 1”, “FIG. 2”, FIG. 3”)—see below:

FIG. 1.
A. Gas Generator
B. Chasis (Platinum -Titanium)
C. H/C Unit
D. Hot Side (H/C Unit)
E. Cold Side (H/C Unit)
F. (Hot/Cold) Open accessway
G. Magnetic trap
H. Laser (Burner)
H1. Control Valve
I. (Paste)/solid compound, (can be radioactive such as Rubidium or Non-radioactive such as Potassium.

FIG. 2
A. Gas Generator
B. Chasis/bracket
C. (H/C) Unit

FIG. 3
A. Charging ring
B. Hot exhaust
C. Electricity (from RITG) to Charging Ring
D. Cold Exhaust
E. Vented Thrust Cap

1. 1^{st} Dedicated (Laser) Gas Generator,

2. 1^{St} Dedicated (Laser) Gas Generator for use in 0.0 g/Space,

3. 1^{St} Design Dedicated (Magnetic Trap) to heat and cool gases for use in 0.0 g/Space,
